(19) United States
(12) Patent Application Publication
(10) Pub. No.: US 2008/0318038 A1
(43) Pub. Date: Dec. 25, 2008

(54) Masking material with liquid-repellent surface

(76) Inventor: Dominick Joseph Fucito, Sagamore Beach, MA (US)

Correspondence Address: Dominick J. Fucito, 8 Jones Lane, Sagamore Beach, MA, 02562, US

(21) Appl. No.: 11/821,615

(22) Filed: Jun. 25, 2007

(51) Int. Cl. B32B 7/12

(52) U.S. Cl. 428/343

(57) ABSTRACT

A masking material which incorporates a liquid-repellent component 407 for use as masking tape and masking sheet is herein disclosed. A masking material according to the present invention comprises a base material 401 having a top surface 402, a bottom surface 403, and at least one masking edge 404. The bottom surface 403 of the base material 401 has an adhesive layer 406 applied thereto. A liquid-repellent component 407 comprises at least the top surface of the one masking edge 404 of the base material 401 so as to at least substantially prevent liquids applied to the liquid-repellent component 407 from forming a continuous liquid layer between the top surface 402 of the base material 401 and the adjacent surface to which the liquid was applied 508.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of Invention

This invention generally relates to an improved masking tape, specifically masking tape related to the protection of surfaces during painting or coating processes.

2. Prior Art

Masking materials have been used for many years to protect surfaces from being painted or coated accidentally. When painting a wall, for example, a masking tape is applied to adjacent surfaces not intended to be painted, such as door and window trim. Subsequent painting along the edges of the wall can then be done more rapidly without concern for accidentally applying paint to the trim, since it is protected by the tape.

Construction of prior art masking tape is illustrated in FIGS. 1 and 2. It is comprised of: a base material 201 having a top surface 202, a bottom surface 203, a masking edge 204, and an opposite edge 205. A layer of adhesive 206 is applied to the bottom surface 203 of the base material 201. It is typically wound onto a hollow tube 102 to form a roll 101.

Although the use of masking tape and similar masking materials for the above purpose are generally effective, one significant problem is commonly encountered. Using the above example of painting a wall, this problem occurs where the paint has accidentally been applied beyond the surface being painted and onto the surface of the tape. This results in a common layer of paint covering both surfaces which, after it dries, acts as a bond between the painted wall and the tape. As the tape is removed, this bond must be broken in order to remove all of the tape successfully. Often however, the capacity of this bond exceeds the tearing strength of the tape. As a result, the tape often tears in this area, leaving the painted portion of the tape on the trim.

Prior art designs have sought to alleviate this problem by utilizing stronger tape. However, this change has resulted in a different problem. The stronger tape has a tendency to unintentionally remove paint which has been just applied to the walls. Again, this occurs in areas where there is a common layer of paint covering both the painted wall and the tape, as described above. As the tape is removed in this area, it has a tendency to peel up some of the paint that has just been applied to the wall. One workaround is to remove the tape when the paint is still wet, and this will prevent the paint from peeling as described. However, in typical applications where two coats of paint are to be applied, this workaround will require that the taping be performed twice, once before each coat of paint is applied.

Prior art design disclosed in U.S. Pat. No. 6,828,008 recognized the tendency for tapes to unintentionally remove newly applied paint. To correct this problem, that design incorporated an absorbent layer intended to slow the curing of the paint which has been applied to it. However, this design has the following weaknesses:

a) The absorbent layer retards but does not stop the paint from curing. Thus, the length of time that the tape can be left on is limited. This is a problem especially where it is intended to apply multiple coats.
b) The absorbent layer must be incorporated during manufacturing in a relatively expensive two step process: first an adhesive must be applied on the surface where the absorbent material will be placed, and then the absorbent material is applied to the adhesive.

### OBJECTS AND ADVANTAGES

The object of the present invention is to provide protection of surfaces during painting or coating processes, with the following advantages over the prior art:

a) added strength to prevent the tape from tearing upon its removal
b) superior composition to prevent the tape from removing newly applied paint after its removal, without the need to remove the tape before the paint or other liquid has cured
c) superior design which is simpler to manufacture.

### BRIEF SUMMARY OF THE INVENTION

The present invention incorporates a liquid-repellent component which prevents the formation of a liquid layer on the masking material. This component provides added strength and thereby reduces the likelihood of tearing the tape tearing upon its removal. This component also causes any liquid applied to the tape to bead, and prevents the formation of a common layer (such as cured paint) covering the surface to be coated and the masking material. This reduces the force required to remove the masking material, also reducing the likelihood of tearing upon its removal. Elimination of the common layer also ensures that the masking material will not inadvertently peel off portions of the newly applied paint or other coating in the unmasked area upon its removal.

### BRIEF DESCRIPTION OF THE SEVERAL VIEWS OF THE DRAWING—

FIG. 1: Side view of prior art roll of masking tape.

FIG. 2: Cross section of prior art masking tape, illustrating composition.

FIG. 3: Side view of preferred embodiment of present invention.

FIG. 4: Cross section of preferred embodiment of present invention, illustrating composition.

FIG. 5: Cross section of prior art design during use.

FIG. 6: Cross section of prior art design during removal after use.

FIG. 7: Cross section of the preferred embodiment during use.

FIG. 8: Cross section of the preferred embodiment during removal after use.

FIG. 9: Cross section of alternate embodiment using liquid-repellent base material.

FIG. 10: Cross section of alternate embodiment using adhesive layer covering only a portion of the bottom surface of the base material.

FIG. 11: Cross section of alternate embodiment incorporating a liquid-resistant layer in addition to the liquid-repellent layer.

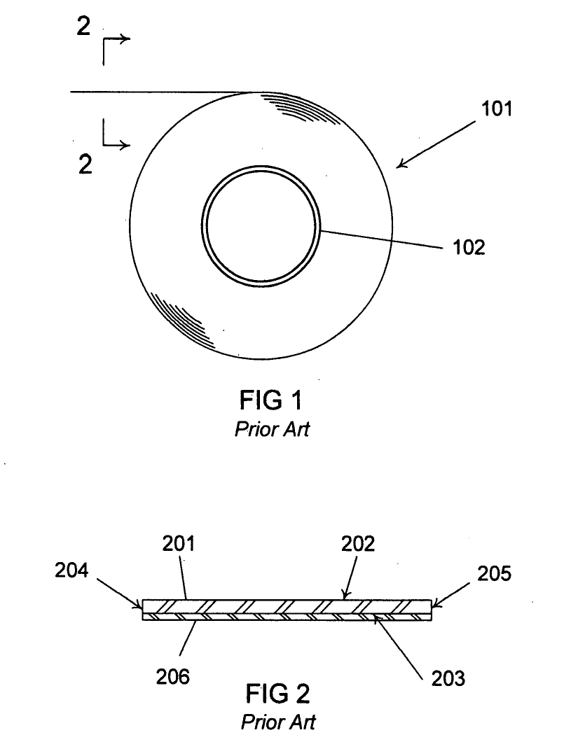

### DETAILED DESCRIPTION OF THE INVENTION—

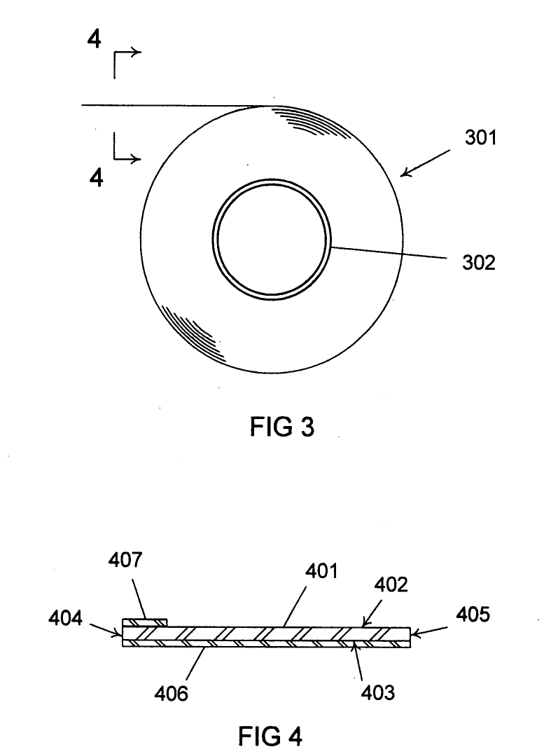

### FIGS. 3 and 4—Preferred Embodiment

The preferred embodiment of the present invention is illustrated in FIGS. 3 and 4. As indicated, an elongated material in the form of a tape is made up of a base material 401, which has a top surface 402, bottom surface 403, masking edge 404, and opposite edge 405. An adhesive layer 406 is applied to the bottom surface 403 of the base material 401. A coating of liquid-repellent silicone 407 is applied to the top surface 402 adjacent to the masking edge 404. Suitable markings (not shown) are placed on the top surface 402 to indicate which side is the masking edge 404. As indicated in FIG. 3, the tape is wound around a hollow tube 302 to form a roll 301.

The preferred embodiment is distinguished from the prior art by the inclusion of the liquid-repellent silicone coating 407 along the masking edge 404. The distinct advantages of including this liquid-repellent silicone coating 407 are discussed in detail below.

### Operation of Preferred Embodiment

To use the preferred embodiment, the tape is applied to the surface to be masked, oriented such that the masking edge 404 is adjacent to the surface to be coated. After the desired number of coats of liquid have been applied to the surface and have cured, the tape is removed.

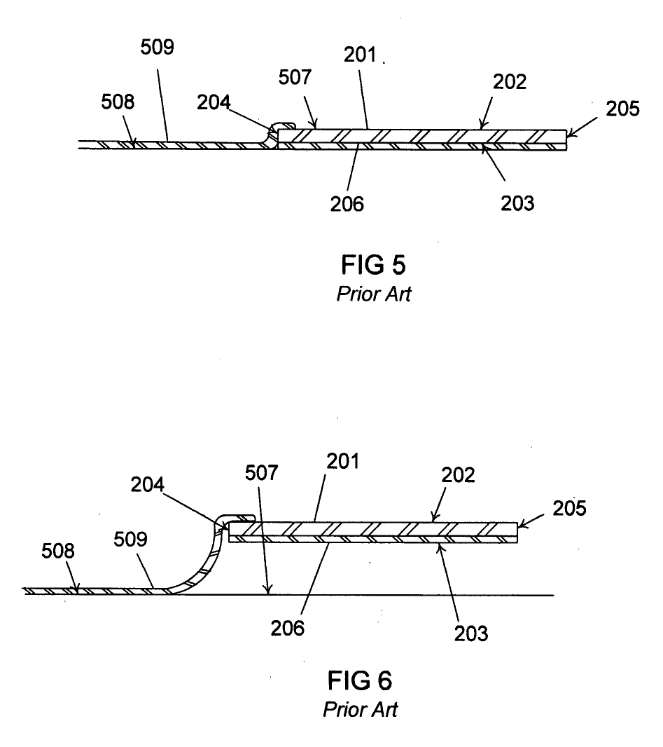

The distinct advantage of the preferred embodiment over the prior art is best illustrated in FIGS. 5 through 8. As indicated in FIG. 5, masking material is applied to the surface to be masked 507. During the subsequent coating process, liquid which is inadvertently applied to the prior art tape forms a continuous coating 509 which extends from the unmasked surface 508 over and onto the base material. Subsequent removal of the tape often results in partial tearing of the tape or removal of the coating from the unmasked surface 508 due to the bond between the coating 509 and the base material 201, as illustrated FIG. 6.

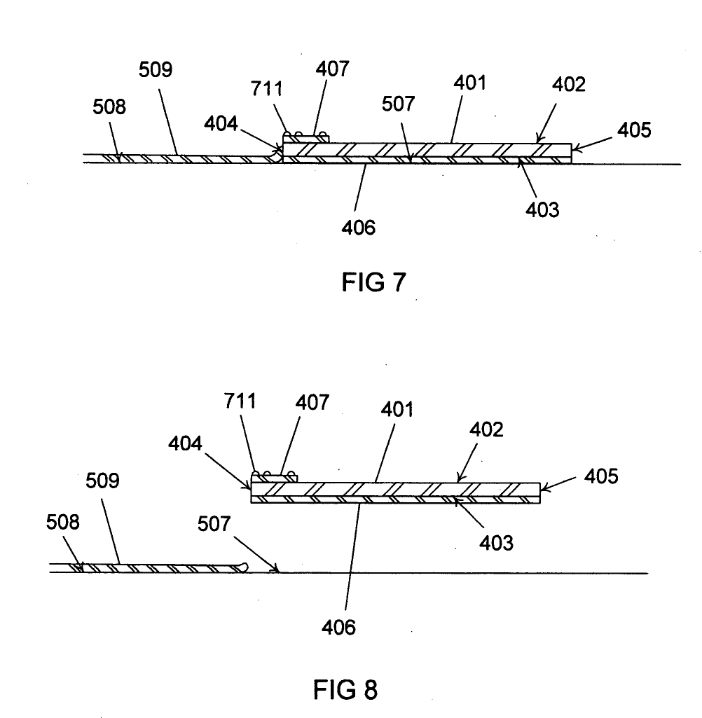

By contrast, the application of silicone 407 on the base material 401 of the present invention provides added strength, making the masking material more resistant to tearing upon its removal. In addition, unlike plastic or other liquid resistant materials, the silicone 407 repels the liquid, causing it to form distinct individual beads 711 which are not continuously connected, as indicated in FIG. 7. Therefore, subsequent removal of masking material will not result in partial removal of the coating 509 on the unmasked surface 508, since they are not bound by a continuous coating. The result is the clean removal of the masking material, as indicated in FIG. 8.

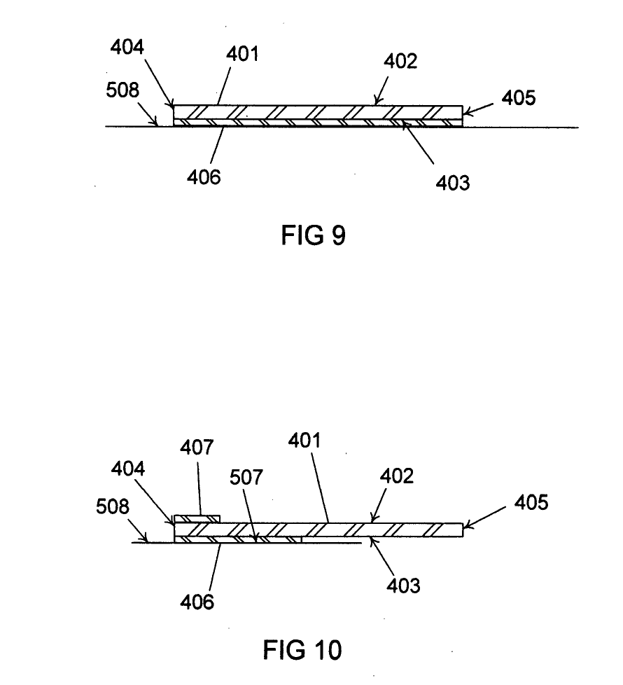

### FIGS. 9, 10, and 11—Alternate Embodiments

One alternate embodiment is illustrated in FIG. 9. This embodiment utilizes liquid-repellent material as the base material 402 of the tape. As such, an additional liquid-repellent coating is not required and is omitted from the design.

A second alternate embodiment is illustrated in FIG. 10. As indicated, this embodiment utilizes an adhesive layer 406 on a portion of the bottom surface 403 of the base material 401 rather than the entire bottom surface 403.

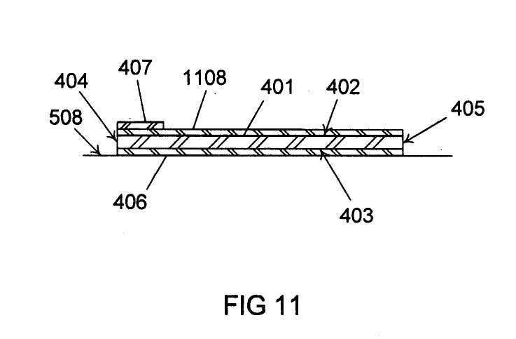

A third alternate embodiment is illustrated in FIG. 11. As indicated, this embodiment incorporates a coating of liquid-resistant material 1108 over the base material 401. It is important to distinguish between a liquid-resistant material and a liquid-repellent material. A liquid-resistant material is distinguished by its ability to prevent a liquid from passing through the material, whereas a liquid-repellent material causes liquid to bead on its surface due to repelling forces developed between the liquid and material surfaces.

A fourth alternate embodiment (not illustrated) utilizes a sheet geometry rather than an elongated tape geometry as the base material 401. This geometry is useful for masking items such as car windows in preparation for spray painting.

### Operation of Alternate Embodiments

To use the alternate embodiment illustrated in FIG. 9, the tape is applied to the surface to be masked 507, oriented such that the one edge is adjacent to the surface to be painted or coated 508. Since the tape is constructed using from liquid-repellent silicone as the base material 401, either edge may be placed adjacent to the surface to be painted or coated 508.

To use the alternate embodiment illustrated in FIGS. 10 and 11, the tape is applied to the surface to be masked 507, oriented such that the masking edge 404 of the base material 401 is adjacent to the surface to be coated 508.

To use the alternate embodiment utilizing a masking sheet in lieu of an elongated tape (not illustrated), the masking sheet is applied to the surface to be masked, ensuring that the liquid repellent component is adjacent to the surface to be coated.

After the desired number of liquid coats have been applied to the unmasked surfaces and have cured, the masking materials discussed in the paragraphs above are removed.

Although the descriptions above of the preferred embodiment and alternate embodiments contain many specifics, these should not be construed as limiting the scope of the invention, but merely providing illustrations of some of the presently preferred embodiments of this invention. For example, substances other than silicone, such as wax or PTFE may be utilized as the liquid-repellent material to prevent the formation of a liquid coating on the masking material. Thus, the scope of the invention should be determined by the appended claims and their legal equivalents, rather than by the examples given.

What is claimed is:

1. A masking material comprising: a base material having a top surface, a bottom surface, and at least one masking edge, the bottom surface of the base material having an adhesive layer applied thereto, covering at least a portion of said bottom surface adjacent to the masking edge, the top surface of the base material having a liquid-repellent coating applied thereto, covering at least a portion of said top surface adjacent to the masking edge to at least substantially prevent liquids applied to the top surface of the masking material from forming a continuous liquid layer between the top surface of the masking material and the adjacent surface to which the liquid was applied.

2. The masking material of claim 1 wherein the liquid-repellent coating is silicone.

3. The masking material of claim 1 wherein the liquid-repellent coating is wax.

4. The masking material of claim 1 wherein the liquid-repellent coating is PTFE.

5. The masking material of claim 1 wherein the liquid-repellent coating prevents the formation of a continuous liquid layer between the top surface of the masking material and the adjacent surface to which the liquid was applied, thereby facilitating the clean release of the masking material from the surface to which the masking material has been applied.

6. The masking material of claim 1 wherein the base material is a paper.

7. The masking material of claim 1 wherein the base material is a crepe ribbon.

8. The masking material of claim 1 wherein the base material is acrylic.

9. The masking material of claim 1 wherein the base material is fashioned of one of a group consisting of polyethylene and polyester.

10. The masking material of claim 1 wherein the liquid-repellent coating acts to at least substantially prevent the formation of a continuous layer of liquid chosen from the group of liquids consisting of oil based paint, latex paint, milk paint, whitewash, stains, glazes, dyes, cleaning compounds, strippers, water, and solvents.

11. The masking material of claim 1 wherein an additional layer of liquid-resistant material is incorporated on the top surface of the base material.

12. The masking material of claim 1 wherein the base material is in the form of an elongate tape.

13. A masking material comprising: a liquid-repellent base material having a top surface, a bottom surface, and at least one masking edge, the bottom surface of the base material having an adhesive layer applied thereto, covering at least a portion of said bottom surface adjacent to the masking edge, said base material to at least substantially prevent liquids applied to the top surface of the masking material from forming a continuous liquid layer between the top surface of the masking material and the adjacent surface to which the liquid was applied.

14. The masking material of claim 13 wherein the liquid-repellent base material is silicone.

15. The masking material of claim 13 wherein the liquid-repellent coating is PTFE.

16. The masking material of claim 13 wherein the liquid-repellent base material is PTFE.

17. The masking material of claim 13 wherein the liquid-repellent base material prevents the formation of a continuous liquid layer between the top surface of the masking material and the adjacent surface to which the liquid was applied, thereby facilitating the clean release of the masking material from the surface to which the masking material has been applied.

18. The masking material of claim 13 wherein an additional layer of liquid-resistant material is incorporated on the top surface of the base material.

19. The masking material of claim 13 wherein the base material is a paper.

20. The masking material of claim 13 wherein the base material is a crepe ribbon.

21. The masking material of claim 13 wherein the base material is acrylic.

22. The masking material of claim 13 wherein the base material is fashioned of one of a group consisting of polyethylene and polyester.

23. The masking material of claim 13 wherein the liquid-repellent coating acts to at least substantially prevent the formation of a continuous layer of liquid chosen from the group of liquids consisting of oil based paint, latex paint, milk paint, whitewash, stains, glazes, dyes, cleaning compounds, strippers, water, and solvents

24. The masking material of claim 13 wherein the base material is in the form of an elongate tape.
